(19) United States
(12) Patent Application Publication
(10) Pub. No.: US 2024/0085106 A1
(43) Pub. Date: Mar. 14, 2024

(54) DRYING CHAMBER FOR A BULK FREEZE DRYING SYSTEM

(71) Applicant: IMA Life North America Inc., Tonawanda, NY (US)

(72) Inventors: FRANCIS W. DEMARCO, North Tonawanda, NY (US); ERNESTO RENZI, Youngstown, NY (US); IVAN HAYNES LANAWAY, Lockport, NY (US); DENNIS POSHELUK, Tonawanda, NY (US); DAVID DEBO, Batavia, NY (US)

(21) Appl. No.: 18/273,097

(22) PCT Filed: Jan. 20, 2022
(86) PCT No.: PCT/US2022/013112

§ 371 Date: Jul. 19, 2023

Related U.S. Application Data
(60) Provisional application No. 63/140,451, filed on Jan. 22, 2021.

(51) Int. Cl. F26B 5/06; F26B 5/04; F26B 17/04

(52) U.S. Cl. CPC F26B 5/065; F26B 5/041; F26B 17/04

(57) ABSTRACT

A freeze drying vessel having a drying chamber and moveable transfer belts each moved by a driven drum. Each transfer belt includes a transfer surface that transports frozen particles. Each transfer surface is arranged vertically in the chamber and moves in an opposite direction than a lower transfer surface. A removal device is located adjacent each driven drum that removes frozen particles from an end of each transfer surface, respectively, to enable removed frozen particles to flow downward to a lower transfer surface. A heating element is located adjacent each transfer belt to sublimate the frozen particles to form freeze dried product.

### CROSS REFERENCE TO RELATED APPLICATION

This application claims the benefit under 35 U.S.C. § 119(e) of copending U.S. Provisional Application No. 63/140,451 filed on Jan. 22, 2021 and entitled BULK FREEZE DRYING SYSTEM, Attorney Docket No. EDW.14A2.US, which is incorporated herein by reference in its entirety and to which this application claims the benefit of priority.

### FIELD OF THE INVENTION

The present disclosure generally relates to bulk freeze drying systems and methods, and more particularly, to a freeze drying chamber having a plurality of moveable product transfer belts wherein each belt is moved by a rotating driven drum that is horizontally spaced apart from an idler drum to form a plurality of horizontal product transfer surfaces that transport the frozen particles in alternating directions wherein at least one product removal device removes frozen particles from an end of each product transfer surface to enable the removed frozen particles to flow downward to a lower product transfer surface to be ultimately discharged through a drying chamber outlet.

### BACKGROUND

Freeze drying is a process that removes a solvent or suspension medium, typically water, from a product. While the present disclosure uses water as the exemplary solvent, other solvents, such as alcohol, may also be removed in freeze drying processes and may be removed with the presently disclosed methods and apparatus.

In a freeze drying process for removing water, the water in the product is frozen to form ice and, under vacuum, the ice is sublimed and the vapor flows to a condenser. The water vapor is condensed on the condenser as ice and is later removed from the condenser. Freeze drying is particularly useful in the pharmaceutical industry, as the integrity of the product is preserved during the freeze drying process and product stability can be guaranteed over relatively long periods of time. The freeze dried product is ordinarily, but not necessarily, a biological substance.

Pharmaceutical freeze drying is often an aseptic process that requires sterile conditions within the freezing and drying chambers. It is critical to assure that all components of the freeze drying system coming into contact with the product are sterile.

Freeze drying of bulk product in aseptic conditions may be performed in a freeze dryer wherein the bulk product is placed in trays. In one example of a conventional freeze drying system 100 shown in FIG. 1, a batch of product 112 is placed in freeze dryer trays 121 within a freeze drying chamber 110. Freeze dryer shelves 123 are used to support the trays 121 and to transfer heat to and from the trays and the product as required by the process. A heat transfer fluid flowing through conduits within the shelves 123 may be used to remove or add heat.

Under vacuum, the frozen product 112 is heated slightly to cause sublimation of the ice within the product. Water vapor resulting from the sublimation of the ice flows through a passageway 115 into a condensing chamber 120 containing condensing coils or other surfaces 122 maintained below the condensation temperature of the water vapor. A coolant is passed through the coils 122 to remove heat, causing the water vapor to condense as ice on the coils.

Both the freeze drying chamber 110 and the condensing chamber 120 are maintained under vacuum during the process by a vacuum pump 150 connected to the exhaust of the condensing chamber 120. Non-condensable gases contained in the chambers 110, 120 are removed by the vacuum pump 150 and exhausted at a higher pressure outlet 152.

Tray dryers are typically designed for aseptic vial drying and are not optimized to handle bulk product. Bulk product must be manually loaded into the trays, freeze dried, and then manually removed from the trays. Handling the trays is difficult, and creates the risk of a liquid spill. Heat transfer resistances between the product and the trays, and between the trays and the shelves, sometimes causes irregular heat transfer. Dried product must be removed from trays after processing, resulting in product handling loss.

Because the process is performed on a large mass of product, agglomeration into a “cake” often occurs, and milling is required to achieve a suitable powder and uniform particle size. Cycle times may be longer than necessary due to resistance of the large mass of product to heating and the poor heat transfer characteristics between the trays, the product and the shelves.

Spray freezing has been used as a technique for creating a particulate frozen bulk product. Issues with current systems include control of the particle size in the frozen bulk product and the efficient removal of heat from the sprayed drops.

### SUMMARY

A freeze drying vessel is disclosed for a freeze drying system having a freezing vessel that generates frozen product particles by freezing drops of fluid product. The vessel includes a freeze drying chamber having a drying chamber inlet that receives the frozen particles, a vacuum port through which the drying chamber is evacuated to a first vacuum pressure and a drying chamber outlet. The vessel also includes a plurality of moveable product transfer belts wherein each belt is moved by a rotating driven drum that is horizontally spaced apart from an idler drum to form a plurality of horizontal product transfer surfaces that transport the frozen particles. Each product transfer surface is arranged vertically in the drying chamber and moves in an opposite horizontal direction than a lower product transfer surface. The product transfer surfaces include top and bottom product transfer surfaces wherein the top product transfer surface receives the frozen particles from the drying chamber inlet.

The vessel also includes at least one product removal device located adjacent each driven drum. The at least one product removal device removes frozen particles from an end of each product transfer surface to enable the removed frozen particles to flow downward to a lower product transfer surface.

Further, the vessel includes at least one heating element located adjacent each product transfer surface. The at least one heating element heats the frozen particles to promote sublimation of the frozen particles to form freeze dried product in powder form that flows downward from the bottom product transfer surface and is discharged through the drying chamber outlet.

Those skilled in the art may apply the respective features of the present invention jointly or severally in any combination or sub-combination.

### BRIEF DESCRIPTION OF DRAWINGS

The exemplary embodiments of the invention are further described in the following detailed description in conjunction with the accompanying drawings, in which:

FIG. 1 depicts a conventional freeze drying system.

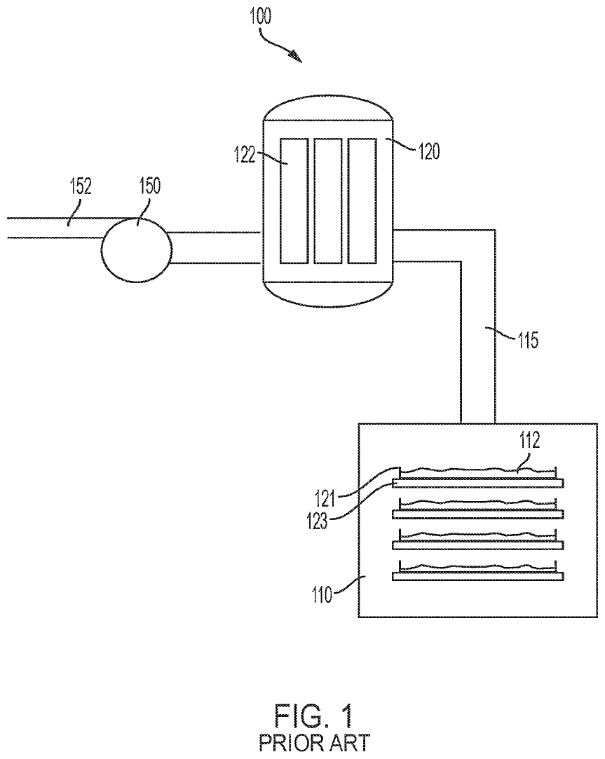

FIG. 2 is a schematic view of a bulk freeze drying system in accordance an aspect of the invention.

FIGS. 3A and 3B are side and top views, respectively, of an interior of an exemplary freezing vessel in accordance with an aspect of the invention.

FIG. 4 is a perspective view of an interior of the freeze drying vessel and drying chamber in accordance with an aspect of the invention.

FIG. 5 depicts a front view of an alternate embodiment of the drying chamber.

FIGS. 6A and 6B illustrate a method of forming freeze dried product in accordance with an aspect of the invention.

FIG. 7A is a perspective view of an alternate embodiment for a freezing column.

FIG. 7B depicts a nozzle assembly for mounting on a top end of each tube in the freezing column shown in FIG. 7A.

FIG. 8A is a cross-sectional view of a further alternate embodiment for a freezing column.

FIG. 8B is a perspective view of the freezing column shown in FIG. 8A.

### DESCRIPTION

Although various embodiments that incorporate the teachings of the present disclosure have been shown and described in detail herein, those skilled in the art can readily devise many other varied embodiments that still incorporate these teachings. The scope of the disclosure is not limited in its application to the exemplary embodiment details of construction and the arrangement of components set forth in the description or illustrated in the drawings. The disclosure encompasses other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

In an aspect of the present disclosure, systems and methods are described for freeze drying an aseptic bulk fluid product in an efficient manner, without compromising the aseptic qualities of the product while also increasing product yield. In addition, the systems and methods of the present disclosure are directed to optimized bulk freeze drying that provides dry product in a powder form.

The processes and apparatus may be advantageously used in drying bulk fluid pharmaceutical products that require aseptic or sterile processing, such as injectables. In this regard, it is important that all components of a freeze drying system coming into contact with the product are sterile. The methods and apparatus may also be used, however, in processing materials that do not require aseptic processing, but require moisture removal while preserving structure, and require that the resulting dried product be in powder form. For example, ceramic/metallic products used as superconductors or for forming nanoparticles or microcircuit heat sinks may be produced using the disclosed techniques.

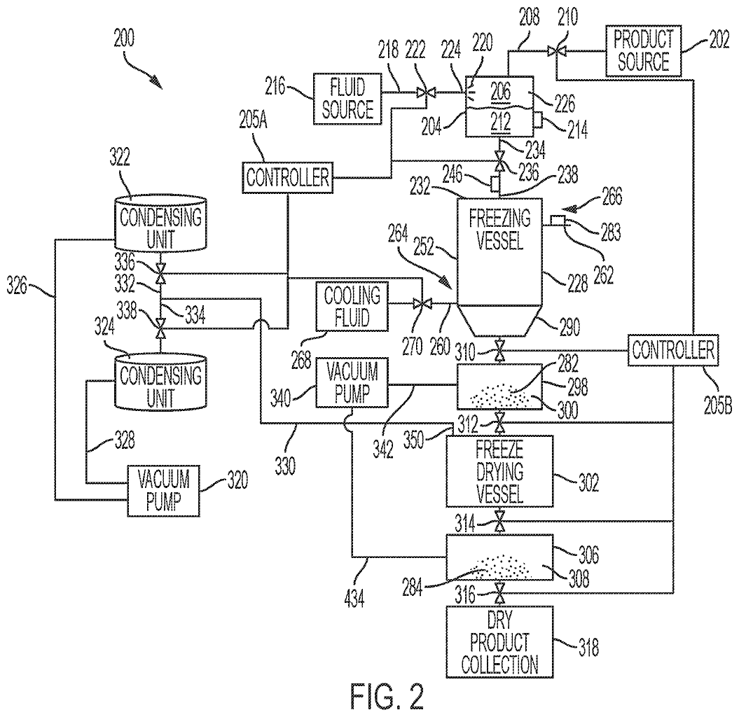

The methods described herein may be performed in part by at least one industrial controller and/or computer used in conjunction with the processing equipment described below. In an embodiment, bulk freeze drying system 200 (FIG. 2) includes controllers 205A and 205B that control opening and closing of valves 222, 236, 270, 336, 338 and 210, 310, 312 314, 316, respectively. The equipment is controlled by a programmable logic controller (PLC) that has operating logic for valves, motors, etc. An interface with the PLC is provided via a personal computer (PC). The PC loads a user-defined recipe or program to the PLC to run. The PLC will upload to the PC historical data from the run for storage. The PC may also be used for manually controlling the devices, operating specific steps such as freezing, defrost, steam in place, etc.

The PLC and the PC include central processing units (CPU) and memory, as well as input/output interfaces connected to the CPU via a bus. The PLC is connected to the processing equipment via the input/output interfaces to receive data from sensors monitoring various conditions of the equipment such as temperature, position, speed, flow, etc. The PLC is also connected to operate devices that are part of the equipment.

The memory may include random access memory (RAM) and read-only memory (ROM). The memory may also include removable media such as a disk drive, tape drive, etc., or a combination thereof. The RANI may function as a data memory that stores data used during execution of programs in the CPU, and is used as a work area. The ROM may function as a program memory for storing a program including the steps executed in the CPU. The program may reside on the ROM, and may be stored on the removable media or on any other non-volatile computer-usable medium in the PLC or the PC, as computer readable instructions stored thereon for execution by the CPU or other processor to perform the methods disclosed herein.

A bulk freeze drying system 200 in accordance an aspect of the invention is shown in FIG. 2. The system 200 includes a source of bulk fluid product 202, such as a liquid product, and a product vessel 204 having a product reservoir 206. The product source 202 and product reservoir 206 are connected by a fluid passageway or conduit 208 that provides fluid communication between the product source 202 and product reservoir 206. The conduit 208 includes a valve 210 that controls a flow of fluid product 212, such as liquid product, into the product reservoir 206. The product vessel 204 also includes a first pressure sensor 214 that measures a static pressure head of product 212 formed when product 212 is introduced into the product reservoir 206. In an embodiment, the first pressure sensor 214 may be a differential pressure transducer (DPT) that provides liquid level readings of product 212 in the product reservoir 206 based on a change in reservoir pressure in the product reservoir 206. The product reservoir 206 may be partially or completely filled with product 212 until a predetermined liquid level of product 212 suitable for operating a nozzle 230 is detected by the first pressure sensor 214. It understood that other devices or sensors may be used to determine the amount or level of product 212 in the product reservoir 206. The product reservoir 206 is also in fluid communication with a sterile adjusting fluid source 216 such as a nitrogen gas (N₂) source through a fluid conduit 218 connected between the fluid source 216 and the product reservoir 206 to enable the injection of a fluid such as a sterile gas 220 into the product reservoir 206. Fluid conduit 218 includes valve 222 that controls gas flow into the product reservoir 206. In an embodiment, an outlet 224 of fluid conduit 218 is located such that the gas 220 is injected into an empty portion 226 of a partially filled product reservoir 206.

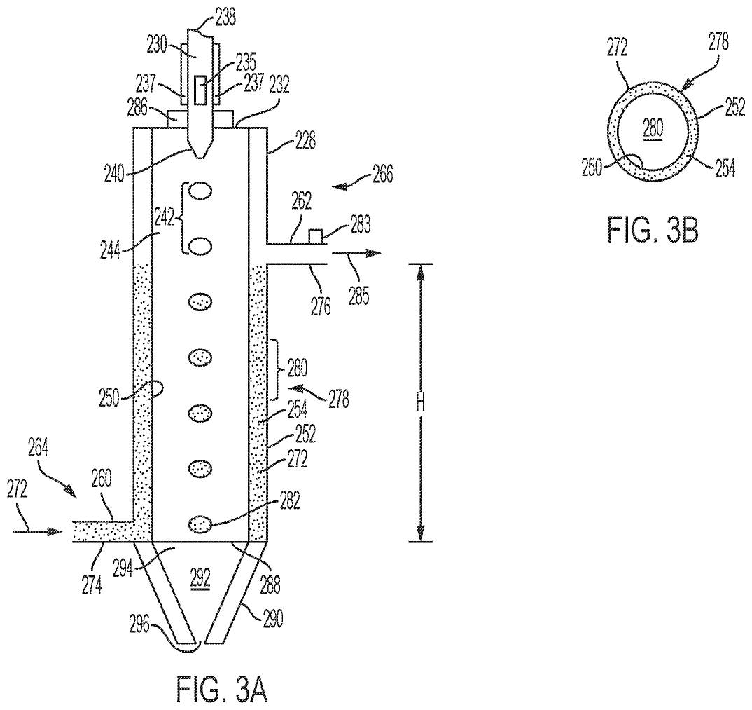

The system 200 also includes a freezing vessel 228 having at least one substantially vertical nozzle 230 (see FIG. 3A) that extends through a top wall 232 of the freezing vessel 228. The freezing vessel 228 and nozzle 230 are located underneath the product reservoir 206. A fluid conduit 234 including valve 236 is connected between the product reservoir 206 and an inlet end 238 of the nozzle 230. When valve 236 is opened, product 212 flows downward by gravity from the product reservoir 206 through the valve 236 and into the nozzle inlet end 238. The product 212 is then sprayed from an outlet end 240 of the nozzle 230 in the form of uniform successive drops 242 that flow downward into a freezing chamber 244 (see FIG. 3A) of the freezing vessel 228 as will be described. In an embodiment, the nozzle may be fabricated from sapphire and includes a piezoelectric actuator 235 configured to produce drops such as nozzles available from Nisco Engineering AG, Zurich, Switzerland.

It is important to control the size of the drops 242, for example, a diameter of the drops 242, when the product 212 is sprayed. In accordance with an aspect of the invention, drop size is dependent upon at least three operational parameters of the nozzle 230. The parameters include a pressure at which the product 212 is provided to the nozzle 230 (i.e. nozzle pressure) and a frequency and amplitude of the signal used to energize the piezoelectric actuator of the nozzle 230. It has been determined by the inventors herein that a predetermined constant nozzle pressure (i.e. a setpoint pressure) should be maintained for the nozzle 230 in order to generate a plurality of successive drops 242 having a desired substantially uniform size. In an embodiment, each drop has a diameter of approximately 1 mm. The nozzle pressure is detected by a second pressure sensor 246 located between the product reservoir 206 and nozzle 230.

During spraying of product 212, product 212 in the product reservoir 206 is consumed and the liquid level of product 212 in the product reservoir 206 decreases, thus decreasing the nozzle pressure below the setpoint pressure. In accordance with an aspect of the invention, sterile gas 220 from the fluid source 216 is then injected into the product reservoir 206 at a suitable gas flow rate. The gas 220 urges against the product 212 thus increasing pressure within the product reservoir 206 and providing a backing pressure. The increase in pressure compensates for the decrease in the liquid level of product 212 and thus maintains the setpoint pressure for the nozzle 230. The gas flow rate for gas 220 injected into product reservoir 206 is controlled or modulated by valve 222 to provide a suitable pressure increase within the product reservoir 206 that achieves the setpoint pressure. The gas flow rate may be increased as needed in order to compensate for further decreases in the liquid level of product 212 and maintain the setpoint pressure for the nozzle 230. Alternatively, the gas flow rate may be decreased as needed, to maintain the setpoint pressure, in order to compensate for increases in the liquid level of product 212 that may occur when product 212 is added to the product reservoir 206. Thus, the pressure sensor 246 provides feedback information used to increase or decrease the gas flow rate for gas 220 injected into the product reservoir 206. In addition, a vibration damping material 237 may be used to isolate the nozzle 230 from ambient vibrations so that a desirable drop uniformity is maintained. In an embodiment, the vibration damping material 237 may be a known vibration damping material or a flexible arrangement may be used such as a flexible sanitary flange.

Referring to FIGS. 3A and 3B, side and top views, respectively, of an interior of the freezing vessel 228 are shown. The freezing vessel 228 includes a tube having an inner circumferential wall 250 that defines the freezing chamber 244. The nozzle outlet end 240 is located in a top portion of the freezing chamber 244 and sprays product 212 in the form of uniform successive drops 242 that flow downward into the freezing chamber 244. The freezing vessel 228 also includes an outer circumferential wall 252 that is spaced apart from the inner wall 250 to form an empty cavity 254 between the inner 250 and outer 252 walls having a substantially annular shape. It is understood that the inner 250 and outer 252 walls and cavity 254 may have other shapes such as oval, arcuate and others. The freezing vessel 228 further includes cavity inlet 260 and outlet 262 conduits that extend from a bottom portion 264 and an upper portion 266 of the outer wall 252, respectively, of the freezing vessel 228. The cavity inlet 260 connects a source 268 of a cooling fluid such as liquid nitrogen (LN₂) to the cavity 254 to provide fluid communication between the LN₂ source 268 and the cavity 254. The cavity inlet 260 includes a valve 270 (FIG. 2) that controls a flow of LN₂ 272 into the cavity 254. The cavity outlet 262 is also in fluid communication with the cavity 254. As will be described, the LN₂ 272 is used to remove heat from a freezing zone 280 in the freezing chamber 274 in order to lower temperature. In this embodiment, the LN₂ 272 is in direct contact with the inner wall 250 as the LN₂ 272 flows through the cavity 254 to remove heat. The heat is absorbed by the LN₂ 272 causing evaporation of a portion of the LN₂ flowing through the cavity 254 resulting in the discharge of two phase flow 285 including N₂ and LN₂ (i.e. combined N₂/LN₂ flow 285) from the cavity 254 via the cavity outlet 262. In an embodiment, the cavity inlet 260 is located such that LN₂ enters the cavity 254 at a location lower than the location from which the combined N₇/LN₇ flow 285 is discharged from the cavity 254 through the cavity outlet 262.

In use, LN₂ 272 flows from the LN₂ supply 268, through the cavity inlet 260, valve 270, enters a lower portion of the cavity 254, rises upward through the cavity 254 and the combined N₂/LN₂ flow 285 is discharged from an upper portion of the cavity 254 through the cavity outlet 262. Thus, the LN₂ 272 rises to a height H in the cavity 54 corresponding to the vertical distance between an inlet bottom portion 274 of the cavity inlet 260 and an outlet bottom portion 276 of cavity outlet 262. This forms a freezing column having an LN₂ jacket 278 that surrounds a portion of the freezing chamber 244. The LN₂ 272 within the cavity 254 lowers the temperature of a corresponding portion of the freezing chamber 244 to form a freezing zone 280 having a freezing zone temperature and a freezing zone height that equals the height H (i.e. height H of freezing zone 280). As previously described, product 212 is sprayed from the nozzle outlet end 240 in the form of uniform successive drops 242 that flow downward into the freezing chamber 244. In accordance with an aspect of the invention, the distance that the drops 242 travel downward through the freezing zone 280 (i.e. the height H) provides a sufficient amount of time for the drops 242 to freeze to form particles of frozen product 282 (i.e. frozen particles 282) when exposed to the freezing zone temperature. In an embodiment, the temperature of the freezing zone 280 is approximately −150 to −185 degrees C. In this embodiment, a freezing zone 280 having a freezing zone temperature sufficient to form the frozen particles 282 is formed.

A temperature sensor 283, such as a resistance temperature detector (RTD), is located at the cavity outlet 262 and monitors the temperature of the combined N₂/LN₂ flow 285 discharged from the cavity outlet 262 (i.e. N₂/LN₂ flow discharge temperature). The N₂/LN₂ flow discharge temperature is indicative of the freezing zone temperature of the freezing zone 280. In accordance with an aspect of the invention, a setpoint temperature for the N₂/LN₂ flow discharge temperature is determined that is indicative of the freezing zone temperature. The freezing zone temperature may be adjusted or regulated by increasing or decreasing the flow of LN₂ 272 through the cavity 254. In particular, increasing LN₂ flow removes additional heat from the freezing zone 280, thus lowering the freezing zone temperature. Conversely, decreasing LN₂ flow through the cavity 254 removes less heat from the freezing zone 280, thus increasing the freezing zone temperature. The LN₂ flow rate through the cavity 254 may be adjusted by controlling valve 270. The nozzle outlet end 240 is located a sufficient distance from the freezing zone 280 to ensure that operation of the nozzle 230 is not affected by the cold temperature of the freezing zone 280. In an embodiment, the nozzle 230 may also include a nozzle heating element 286, such as an electric heater, to heat the nozzle 230 and maintain the nozzle 230 at a suitable operating temperature.

The height H of the freezing zone 280 is selected based upon the freezing temperature of the product being sprayed and the volume of the drops. In order to accommodate products 212 having different freezing temperatures and drop volumes, the height H of the freezing zone 280 may be increased or decreased by moving either the cavity inlet 260 or the cavity outlet 262, or moving both the cavity inlet 260 and the cavity outlet 262, relative to the outer wall 252. In an embodiment, the cavity inlet 260 may be moved vertically upward relative to the outer wall 252 to decrease the height H of freezing zone 280. In particular, movement of the cavity inlet 260 upward in order to decrease the height H enables freezing of the drops 242 to occur closer to the nozzle outlet end 240 than would occur by moving the cavity outlet 262 downward to decrease the height H. The outer wall 252 may include more than one attachment point for attaching either the cavity inlet 260 or cavity outlet 262, or both, in different vertical positions on the outer wall 252 in order to move the cavity inlet 260 or cavity outlet 262, or both, to change the height H. Alternatively, a vertically moveable attachment point may be used for connection to either the cavity inlet 260 or cavity outlet 262, or both, in order to change the height H.

After the frozen particles 282 pass through the freezing zone 280, the frozen particles 282 flow downward through a freezing chamber outlet 288 defined by the inner wall 250. A funnel element 290 is attached to the freezing vessel 228. The funnel element 290 includes an internal passageway 292 that decreases in size from a funnel inlet 294 to a funnel outlet 296 to form a tapered passageway 292. The frozen particles 282 from the freezing chamber outlet 288 enter the funnel inlet 294, are guided downward by the tapered passageway 292 and discharged from the funnel outlet 296.

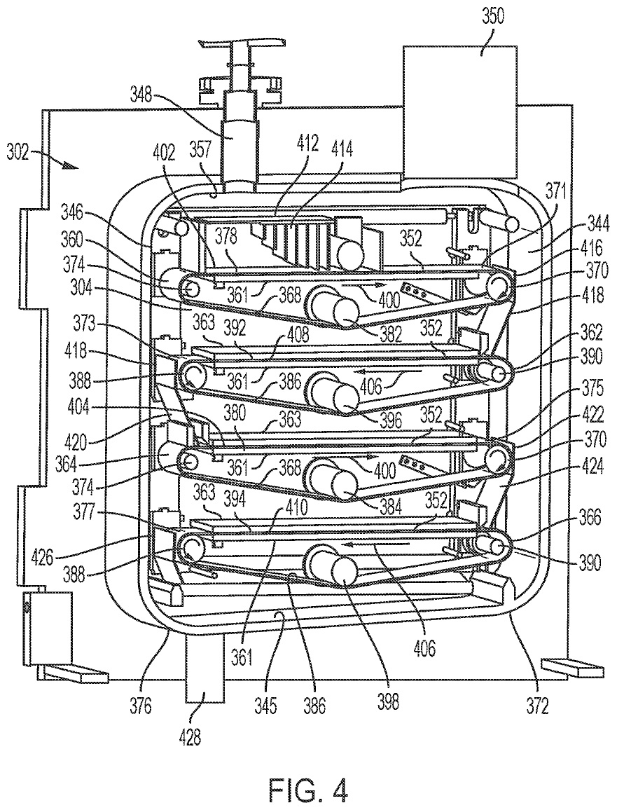

The system 200 further includes an upper intermediate vessel 298 having an upper intermediate chamber 300, a freeze drying vessel 302 having a freeze drying chamber 304 (see FIG. 4) and a lower intermediate vessel 306 having a lower intermediate chamber 308. The freeze drying vessel 302 is located underneath the upper intermediate vessel 298 and the lower intermediate vessel 306 is located underneath the freeze drying vessel 302. Valves 310 and 312 are connected between the funnel element 290 and the upper intermediate vessel 298 and between the upper intermediate vessel 298 and the freeze drying vessel 302, respectively. Valves 314 and 316 are connected between the freeze drying vessel 302 and the lower intermediate chamber 308 and the lower intermediate chamber 308 and a dry product collection canister 318, respectively. In an embodiment, valves 310, 312, 314 and 316 may be split butterfly valves.

In addition, the system 200 includes a first vacuum pump 320 that is in fluid communication with known first 322 and second 324 condensing units through first 326 and second 328 vacuum lines connected between the first vacuum pump 320 and the first 322 and second 324 condensing units, respectively. A drying chamber vacuum line 330 extending from the drying chamber 304 is connected between first 332 and second 334 condensing vacuum lines extending from the first 322 and second 324 condensing units, respectively. The first 332 and second 334 condensing vacuum lines include valves 336 and 338, respectively. The drying chamber 304 is in fluid communication with the first vacuum pump 320 and the first condensing unit 322 when valve 336 is opened. Alternatively, drying chamber 304 is in fluid communication with the first vacuum pump 320 and second condensing unit 324 when 338 valve is opened. When valve 336 is opened and valves 338, 312, 314 are closed, the drying chamber 304 is evacuated by the first vacuum pump 320 to a first vacuum pressure. Alternatively, the drying chamber 304 is evacuated to the first vacuum pressure when valve 338 is opened and valves 336, 312, 314 are closed. The upper intermediate chamber 300 is in fluid communication with a second vacuum pump 340 through a second vacuum line 342 connected between the upper intermediate chamber 300 and the second vacuum pump 340.

During operation of the system 200, the freezing chamber 244 and the tapered passageway 292 are maintained at approximately atmospheric pressure. Valve 310 is closed during the generation of a batch of frozen particles 282 in the freezing vessel 228. Once the batch is complete, valve 310 is opened thus causing the frozen particles 282 to flow downward by gravity from the funnel outlet 296 through valve 310 and into the upper intermediate chamber 300. Once the frozen particles 282 from the funnel element 290 are transferred into the upper intermediate chamber 300, valve 310 is closed. With valve 312 also closed, the upper intermediate chamber 300 is then evacuated by the second vacuum pump 340 to a vacuum pressure substantially similar to the vacuum pressure in the drying chamber 304 (i.e. the first vacuum pressure). Once the first vacuum pressure is reached, valve 312 is opened to enable the frozen particles 282 to flow downward by gravity from the upper intermediate chamber 300 through valve 312 and into the drying chamber 304. Once the frozen particles 282 from the upper intermediate chamber 300 are transferred into the drying chamber 304, valve 312 is closed. The upper intermediate chamber 300 is then returned to approximately atmospheric pressure in preparation for the next batch of frozen particles 282. The funnel element 290, valve 310, upper intermediate vessel 298 and valve 312 may include at least one cooling element, such as a silicone oil cooling jacket, that cools the funnel element 290, valve 310, upper intermediate vessel 298 and valve 312 to a temperature that inhibits thawing of the frozen particles 282 that come into contact with walls and other surfaces of the funnel element 290, valve 310, upper intermediate vessel 298 and valve 312.

Referring to FIG. 4, a perspective view of an interior of the freeze drying vessel 302 and drying chamber 304 in accordance with an aspect of the invention is shown. The drying chamber 304 includes first 344 and second 346 side walls, a bottom wall 345 and a top wall 357 including a drying chamber inlet 348 that receives the frozen particles 282 from valve 312 as previously described. The drying chamber 304 also includes a vacuum port 350 in the top wall 357 that is in fluid communication with the drying chamber vacuum line 330. During operation of the system 200, the drying chamber 304 is evacuated by the first vacuum pump 320 to the first vacuum pressure via the vacuum port 350.

The drying chamber 304 further includes a plurality of moveable product transfer elements 352 that each move the frozen particles 282 in a substantially horizontal direction. The product transfer elements 352 are each oriented horizontally and spaced apart vertically in the drying chamber 304. Each product transfer element 352 may be configured as a moveable continuous product transfer belt. In an embodiment, the drying chamber 304 may include first 360, second 362, third 364 and fourth 366 continuous product transfer belts spaced apart vertically in the drying chamber 304. The belts 360, 362, 364, 366 may be fabricated from a material suitable for contact with the frozen particles 282 such as stainless steel or a polymer. It is understood that additional or fewer belts may be used.

An inner surface 368 of the first 360 and third 364 belts is in contact with a respective first driven pulley or drum 370 located on a first side 372 of the drying chamber 304, a first idler drum 374 located on a second side 376 of the drying chamber 304 opposite the first side 372 such that the first 360 and third 364 belts form first 378 and third 380 horizontal belt sections between the first driven drum 370 and second idler drum 374, respectively. The inner surface 368 of the first 360 and third 364 belts is also in contact with first 382 and third 384 moveable belt tensioner devices that are spaced apart vertically downward from the first 378 and third 380 horizontal belt sections, respectively.

An inner surface 386 of the second 362 and fourth 366 belts is in contact with a respective second driven drum 388 located on the second side 376 of the drying chamber 304, a first idler drum 390 located on the first side 372 of the drying chamber 304 such that the second 362 and fourth 366 belts form second 392 and fourth 394 horizontal belt sections between the second driven drum 388 and second idler drum 390, respectively. The inner surface 386 of the second 362 and fourth 366 belts is also in contact with second 396 and fourth 398 moveable belt tensioner devices that are spaced apart vertically downward from the second 392 and fourth 394 horizontal belt sections, respectively. A position of the first 382 and third 384 and second 396 and fourth 398 tensioner devices is adjustable in a vertical direction to maintain a desired tension in the first 360 and third 364 and the second 362 and fourth 366 belts to ensure a desired horizontal movement of the first 378 and third 380 and second 392 and fourth 394 horizontal belt sections, respectively. The belt tensioners 382, 396, 384, 398 may each be a pulley whose position is adjustable in a vertical direction to maintain a desired tension in a respective belt 360, 362, 364, 366.

The first driven drums 370 that drive the first 360 and third 364 belts and the second driven drums 388 that drive the second 362 and fourth 366 belts may be magnetically coupled to a chamber drive system that is located outside of the drying chamber 304 to rotate first 370 and second 388 driven drums in order to provide an aseptic environment. Alternatively, the first driven drums 370 and the second driven drums 388 may be attached to the external drive system via an associated drive shaft that extends through a wall of the drying chamber 304. An axial seal system may be used to seal each drive shaft to maintain an aseptic environment within the drying chamber 304.

In operation, the first driven drums 370 associated with the first 360 and third 364 belts, respectively, are each driven to rotate in clockwise directions to cause continuous movement of the first 360 and third 364 belts between the first driven drum 370 and second idler drum 374, respectively, to form continuous first 378 and third 380 horizontal belt sections that move horizontally in a first direction 400 (see arrow) from the second side 376 to the first side 372 of the drying chamber 304. An outer surface of the first 378 and third 380 horizontal belt sections forms first, or top, 402 and third 404 product transfer surfaces, respectively, that receive and transport the frozen particles 282 in the first direction 400.

The second driven drums 388 associated with the second 362 and fourth 366 belts, respectively, are each driven to rotate in counterclockwise directions to cause continuous movement of the second 362 and fourth 366 belts between the second driven drum 388 and first idler drum 390, respectively, to form continuous second 392 and fourth 394 horizontal belt sections that move horizontally in a second direction 406 (see arrow) from the first side 372 to the second side 376 and opposite the first direction 400. An outer surface of the second 392 and fourth 394 horizontal belt sections forms second 408 and fourth 410 product transfer surfaces, respectively, that receive and transport the frozen particles 282 in the second direction 406. Thus, the first 402, second 408, third 404 and fourth 410 product transfer surfaces move in alternating horizontal directions.

In operation, the frozen particles 282 from the drying chamber inlet 348 flow downward, or drop, by gravity onto an inlet product distribution device 412 located between the drying chamber inlet 348 and the first product transfer surface 402 of the first belt 360. The inlet product distribution device 412 serves to arrange the frozen particles 282 into a substantially even layer or distribution onto the first product transfer surface 402. In an embodiment, the inlet product distribution device 412 may include an array of vertical plate elements 414 having increasing lengths and arranged to form a substantially even layer of frozen particles 282 onto the first product transfer surface 402. Alternatively, the inlet product distribution device 412 may include a vibratory element that vibrates the frozen particles 282 to provide a substantially even layer of frozen particles 282 onto the first product transfer surface 402.

The frozen particles 282 on the first product transfer surface 402 are then moved in the first direction 400 by the first belt 360 toward a first product removal device 416 located adjacent the first driven drum 370 associated with first belt 360. In an embodiment, the first product removal device 416, along with the second 418, third 422 and fourth 426 product removal devices as will be described, may include a scraper blade element configured for removing the frozen particles 282. The product removal device 416 may also be located adjacent an idler drum. The first product removal device 416 serves to remove frozen particles 282 from the first product transfer surface 402. The removed frozen particles 282 then flow downward from a first end 371 of the first belt 360 or cascade onto a first belt product distribution device 418 downwardly adjacent the first product removal device 416 to provide a substantially even layer of frozen particles 282 onto the second product transfer surface 408 of the second belt 362 located underneath the first belt 360.

The frozen particles 282 on the second product transfer surface 408 are then moved in the second direction 406 by the second belt 362 toward a second product removal device 418 located adjacent the second driven drum 388 associated with the second belt 362. The second product removal device 418 then removes the frozen particles 282 from the second product transfer surface 408. The removed frozen particles 282 then flow downward from a second end 373 of the second belt 362 or cascade onto a second belt product distribution device 420 downwardly adjacent the second product removal device 418 to provide a substantially even layer of frozen particles 282 onto the third product transfer surface 404 of the third belt 364 located underneath the second belt 362.

Movement of the frozen particles 282 with respect to the remaining third 364 and fourth 366 belts corresponds to the movement described in relation to the first 360 and second 362 belts, respectively. In particular, the frozen particles 282 on the third product transfer surface 404 are then moved in the first direction 400 by the third belt 364 toward a third product removal device 422 located adjacent the first driven drum 370 associated with third belt 364. The third product removal device 422 then removes frozen particles 282 from the third product transfer surface 404. The removed frozen particles 282 then flow downward from a third end 375 of third belt 364 or cascade onto a third belt product distribution device 424 downwardly adjacent the third product removal device 422 to provide a substantially even layer of frozen particles 282 onto the fourth product transfer surface 410 of the fourth belt 366 located underneath the third belt 364.

The frozen particles 282 on the fourth product transfer surface 410 are then moved in the second direction 406 by the fourth belt 366 toward a fourth product removal device 426 located adjacent the second driven drum 388 associated with the fourth belt 366. The fourth product removal device 426 then removes the frozen particles 282 or freeze dried product 284 as will be described from the fourth product transfer surface 410.

While the drying chamber 304 is under vacuum as previously described, the frozen particles 282 located on the first 402, second 408, third 404 and fourth 410 product transfer surfaces are simultaneously heated in order to heat the frozen particles 282 and promote sublimation of the frozen particles 282. In an aspect of the invention, the drying chamber 304 further includes heating elements that provide radiant heat to heat the frozen particles 282 and promote sublimation of the frozen particles 282 as the particles move on the first, second, third and fourth belts. In an embodiment, a lower heating element 361 may be located underneath the first horizontal belt section 378 of the first belt 360. Further, the second 392, third 380 and fourth 394 horizontal belt sections of the second 362, third 364 and fourth 366 belts, respectively, may be located between upper 363 and lower 361 associated heating elements. The upper 363 and lower 361 heating elements are spaced apart from corresponding first 378, second 392, third 380 and fourth 394 horizontal belt sections to provide sufficient heat to promote sublimation of the frozen particles 282. A temperature of each heating element 363, 361 is independently adjustable to provide a desired amount of heat. The upper 363 and lower 361 heating elements may include an electromagnetic energy source, an electric heater, a heat transfer fluid source or other sources. In a further embodiment, microwave energy is utilized to deliver the sublimation energy to the frozen particles 282. In this embodiment, the upper 363 and lower 361 heating elements are replaced with equipment for microwave heating, which may include a microwave antenna or generator, a microwave cage (a type of Faraday cage) and microwave stirrers that provide even distribution of microwaves across the frozen particles 282. Alternate materials of construction for components of the drying chamber 304 may be utilized when using microwave energy.

Using the upper 363 and lower 361 heating elements to heat the frozen particles 282 as the frozen particles 282 are moved by the first 360, second 362, third 364 and fourth 366 belts promotes sublimation of the frozen particles 282 and ultimately forms freeze dried product 284 in powder form. The frozen product 284 is then removed from the fourth product, or bottom, transfer surface 410 by the fourth product removal device 426. The frozen product 284 then falls by gravity from a fourth end 377 of the fourth belt 366 and through a drying chamber outlet 428 that extends through the bottom wall 345 of the drying chamber 304 and onto valve 314 (see FIG. 2).

As frozen liquid in the product 212 sublimates, vapor is drawn from the drying chamber 304 by the first vacuum pump 320 via the drying chamber vacuum line 330 and is collected in the first condensing unit 322 when valve 336 is opened (see FIG. 2). Cooled condensing surfaces in the first 322 and second 324 condensing units collect the vapor. In the case of water vapor, the vapor condenses as ice on the condensing surfaces. For example, a condensing surface may include a condensing coil maintained below the condensation temperature of the water vapor. A coolant is passed through the coils 122 to remove heat, causing the water vapor to condense as ice on the coils.

When an ice capacity of the first condensing unit 322 is reached, valve 336 is closed and valve 338 is opened to allow vapor to be collected in the second condensing unit 324. Condensed ice is then simultaneously removed from the first condensing unit 322 so that the first condensing unit 322 may again be utilized to collect vapor when the second condensing unit 324 reaches its ice capacity. When the first condensing unit 322 again reaches its capacity, the previously described process of switching to the second condensing unit 324 to collect vapor, while simultaneously removing ice from the first condensing unit 322, is repeated. In accordance with an aspect of the invention, either the first 322 or second 324 condensing unit may be used to collect vapor while ice is removed from the condensing unit that is not being used (i.e. for example, vapor is collected in the first condensing unit 322 while ice is simultaneously removed from the second condensing unit 324 or the second condensing unit 324 is used to collect vapor while ice is simultaneously removed from the first condensing unit 322) to enable continuous operation of the system 200. In an embodiment, more than two condensing units may be used to collect vapor.

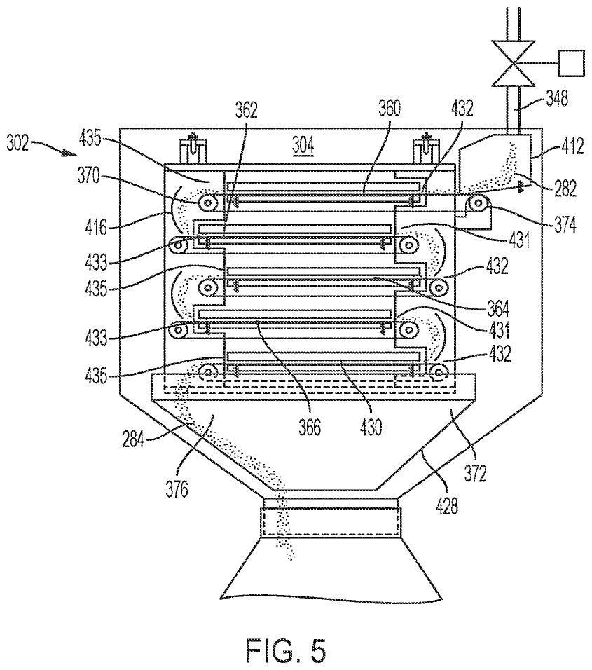

FIG. 5 depicts a front view of an alternate embodiment of the drying chamber 304. In this embodiment, the drying chamber 304 includes first 360, second 362, third 364, fourth 366 and fifth 430 belts which are arranged in a staggered configuration. For example, first end portions 432 of the first 360, third 364 and fifth 430 belts are located closer to the first side 372 of the drying chamber 304 than the first end portions 431 of the second 362 and fourth 366 belts. Thus, the first end portions 432 of the third 364 and fifth 430 belts extend horizontally beyond the first end portions 431 of the second 362 and fourth belts 366, respectively. In addition, second end portions 433 of the second 362 and fourth 366 belts are located closer to the second side 376 of the drying chamber 304 than the second end portions 435 of the first 360, third 364 and fifth 430 belts, respectively. Thus, the second end portions 433 of second 362 and fourth 366 belts extend horizontally beyond the second end portions 435 of the first 360 and second 364 belts. In accordance with an aspect of the invention, the first end portions 432 of the third 364 and fifth 430 belts, and the second end portions 433 of the second 362 and fourth 366 belts, provide additional surface area for receiving frozen particles 282 from a preceding shelf. In an embodiment, the separate belts 360, 362, 364, 366 may be replaced a single contiguous belt. In addition, a belt tensioner is not used in the embodiment shown in FIG. 5. Further, the product transfer surfaces 402, 408, 404, 410 may be angled as desired to assist in moving the frozen particles 282.

In operation, the first 360, second 362, third 364, fourth 366 and fifth 430 belts are moved at a sufficiently slow speed such that the frozen particles 282 are transferred from one belt surface to an adjacent belt located below the first belt in a cascade fashion. The slow movement of each belt 360, 362, 364, 366, 430 may be paused in order to increase a dwell time within the drying chamber 304. The belts 360, 362, 364, 366, 430 may be considered product contact parts which may necessitate being able to change a belt or more than one belt in a manner that does not require excessive disassembly of the drying chamber 304. In order to facilitate changing the belts 360, 362, 364, 366, 430, the upper 363 and lower 361 heating elements may be attached to the walls of the freeze drying vessel 302 to form a cantilevered arrangement to allow clear access to release belt tension and change belts 360, 362, 364, 366, 430.

Referring back to FIG. 2, the lower intermediate chamber 308 is in fluid communication with the second vacuum pump 340 through a third vacuum line 434 connected between the lower intermediate chamber 308 and the second vacuum pump 340. When valves 314 and 316 are closed, the lower intermediate chamber 308 is evacuated to the first vacuum pressure by the second vacuum pump 340. Once a batch of freeze dried product 284 is received from the eighth shelf 372 as previously described, valve 314 is opened thus causing the freeze dried product 284 to flow downward by gravity into the lower intermediate chamber 308. Once the batch of freeze dried product 284 is transferred to the lower intermediate chamber 308, valve 314 is closed and the lower intermediate chamber 308 is returned to approximately atmospheric pressure. Valve 316 is then opened to enable discharge of the freeze dried product 284 by gravity into dry product collection canister 318, such as a sterile stainless steel container. The freeze dried product 284 may then be used to fill vessels such as vials, syringes, etc. for shipment. Alternatively, the freeze dried product 284 may be deposited into a hopper feeder that serves as a feeder for directly filling freeze dried product 284 into the vials, syringes etc. without using a collection canister 318. Further, the lower intermediate chamber 308 is evacuated to the first vacuum pressure in preparation for receiving a next batch of freeze dried product 284.

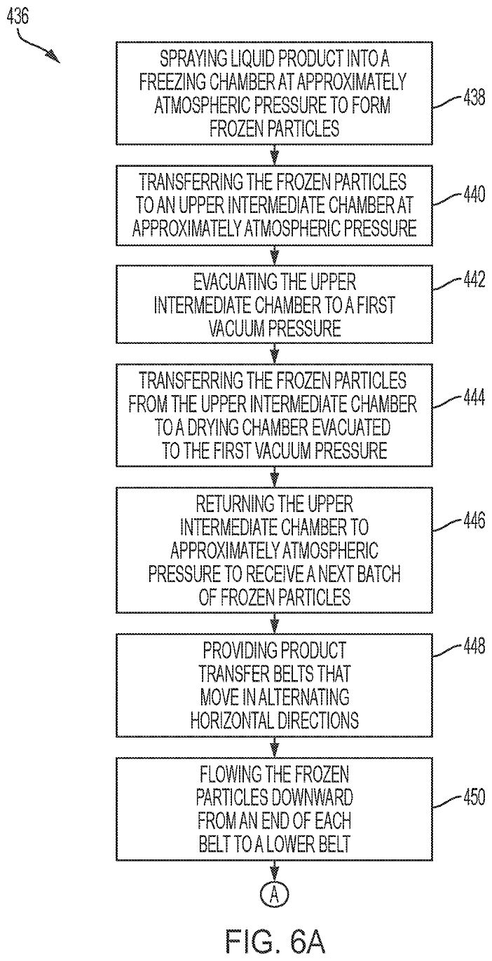

Referring to FIGS. 6A and 6B, a method 436 of forming freeze dried product 284 in accordance with an aspect of the invention is shown. At step 438, fluid product 212 is sprayed into a freezing chamber 244 that is at approximately atmospheric pressure to form frozen particles 282. At step 440, the frozen particles 282 are then transferred to an upper intermediate chamber 300 that is at approximately atmospheric pressure. At step 442, the upper intermediate chamber 300 is evacuated to a first vacuum pressure. At step 444, the frozen particles 282 are transferred from the upper intermediate chamber 300 to a drying chamber 304 that is also evacuated to the first vacuum pressure. Once the frozen particles 282 are transferred to the drying chamber 304, the upper intermediate chamber 300 is returned to approximately atmospheric pressure in preparation for receiving a next batch of frozen particles 282 at step 446. The method 436 also includes providing a plurality of horizontal product transfer belts 360, 362, 364, 366 arranged vertically in the drying chamber 304 wherein the product transfer belts 360, 362, 364, 366 move the frozen particles 282 in alternating horizontal directions at step 448. At step 450, the frozen particles 282 flow downward from an end 371, 373, 375, 377 of each product transfer belt 360, 362, 364, 366, respectively, to a lower product transfer belt. The frozen particles 282 are simultaneously heated to cause sublimation of frozen liquid to produce a vapor and form freeze dried product 284 in powder form at step 452. At step 454, at least two condensing units 322, 324 are provided wherein a condensing unit is used to collect vapor while ice is simultaneously removed from another condensing unit that has reached ice capacity to enable continuous operation of the system 200. The freeze dried product 284 is then transferred from the drying chamber 304 to a lower intermediate chamber 308 evacuated to the first vacuum pressure at step 456. The lower intermediate chamber 308 is returned to approximately atmospheric pressure at step 458. The freeze dried product 284 is then transferred from the lower intermediate chamber 308 into a dry product collection canister or hopper feeder 318 at step 460. At step 462, the lower intermediate chamber 308 is evacuated to the first vacuum pressure in preparation for receiving a next batch of freeze dried product 284.

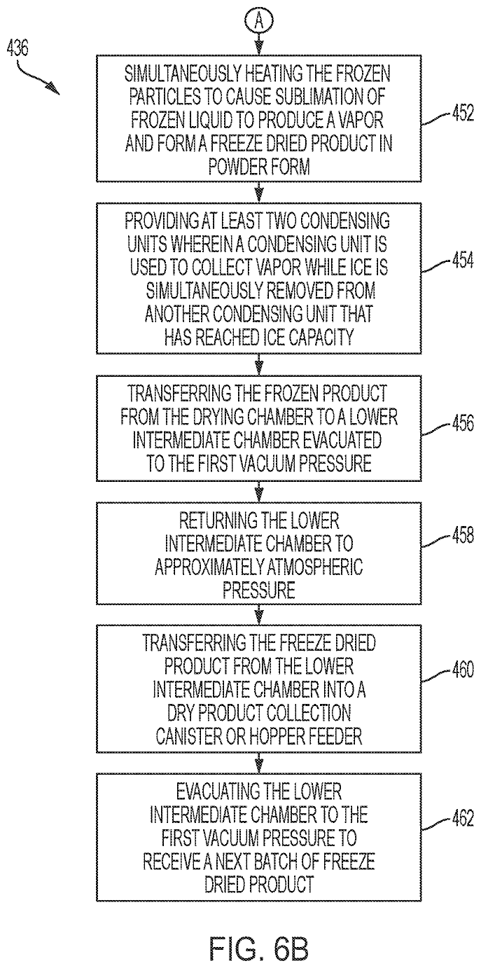

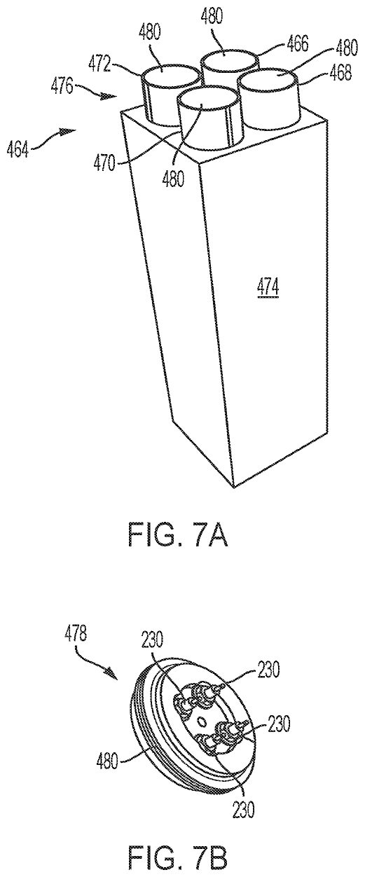

Referring to FIG. 7A, a perspective view of an alternate embodiment for a freezing column 464 is shown. In this embodiment, the freezing column 464 may include more than one vertical tube wherein each tube defines an associated freezing chamber 244 (see FIG. 3A). In FIG. 7A, an exemplary freezing column 464 is shown that includes first 466, second 468, third 470 and fourth 472 hollow tubes each located within a cryogenically cooled freezing vessel 474 having a substantially rectangular shape. A top portion 476 of each tube 466, 468, 470, 472 may extend above the freezing vessel 474. Referring to FIG. 7B, a nozzle assembly 478 for mounting on a top end 480 of each tube 466, 468, 470, 472 is shown. The nozzle assembly 478 includes a mounting wall 480 having at least one substantially vertical nozzle 230 (see FIG. 3A) that extends through the mounting wall 480 to form the nozzle assembly 478. The nozzle 230 is connected to the fluid conduit 234 as previously described in relation to FIG. 3A. In an embodiment, each nozzle assembly 478 may include up to four nozzles 230.

In accordance with an aspect of the invention, other shapes may be used for the freezing vessel 474 such as square, round and others. The freezing vessel 474 may be cooled by LN₂ or a flow of LN₂ that is maintained at a setpoint temperature indicative of a freezing zone temperature within each tube 466, 468, 470, 472. As previously described in relation to FIGS. 3A and 3B, product 212 is sprayed from the nozzle outlet end 240 in the form of uniform successive drops 242 that flow downward into the freezing chamber 244. The distance that the drops 242 travel downward through the freezing zone 280 in each respective tube provides a sufficient amount of time for the drops 242 to freeze to form the frozen particles 282 when exposed to the freezing zone temperature. The frozen particles 282 from the tubes then flow downward into a single funnel element 290 and into the upper intermediate chamber 300 via valve 310.

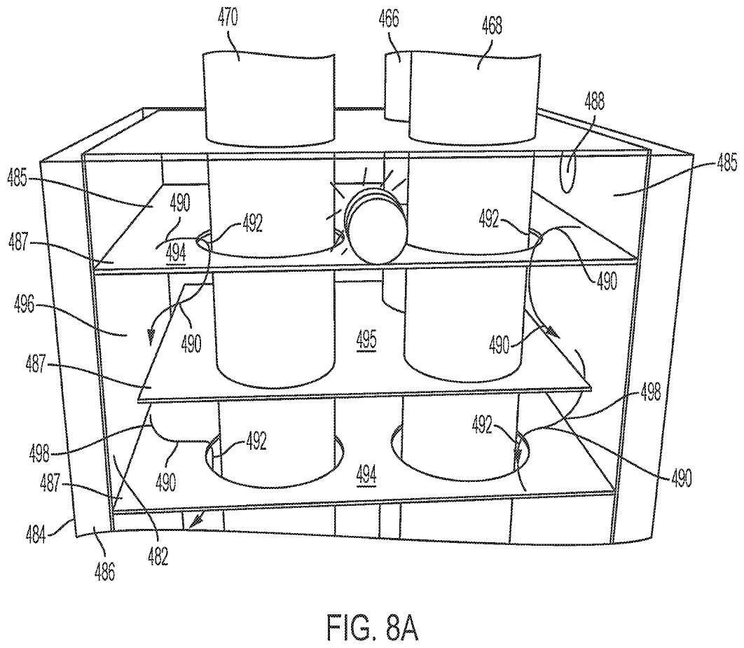

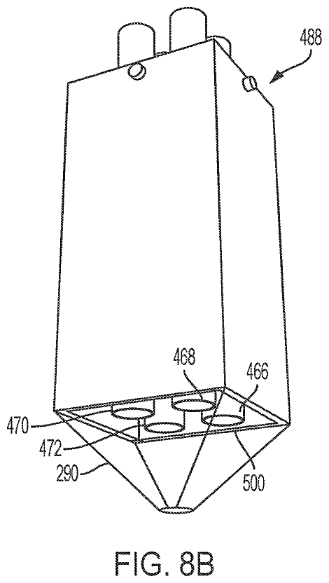

Referring to FIG. 8A, a cross-sectional view of a further alternate embodiment for a freezing column 474 is shown. In this embodiment, the freezing column 474 includes spaced apart inner 482 and outer 484 walls that form a wall chamber 486. The inner wall 482 is also spaced apart from the tubes 466, 468, 470, 472 to form a column space 485 between each tube 466, 468, 470, 472 and the inner wall 482. The tubes 466, 468, 470, 472 extend through a plurality of vertically spaced apart baffles 487 that are oriented horizontally within the freezing column 474. Referring to FIG. 8B, a perspective view of the freezing column 474 is shown. The freezing column 474 includes an inlet device 488 that extends through the outer 484 and inner 482 walls. The inlet device 488 serves to deliver sterile LN₂ at atmospheric pressure in the form of a spray that is sprayed onto the outside of the tubes 466, 468, 470, 472. The wall chamber 486 between the walls 482, 484 is filled with LN₂ to form an LN₂ jacket. The LN₂ jacket is configured to operate at a pressure above atmospheric pressure in order to create a wall temperature that is warmer than the liquification point of the atmospheric spray LN₂. The spray LN₂ is vaporized upon contact with the outside of the tubes 466, 468, 470, 472 to form a sterile LN₂ vapor 490 that cools the tubes 466, 468, 470, 472.

In accordance with an aspect of the invention, a first gap 492 is formed between a first set of alternating baffles 494 and each tube 466, 468, 470, 472. A second set of alternating baffles 495 (i.e., the remaining baffles) are configured such that a second gap 496 is formed between each remaining alternating baffle 495 and the inner wall 482. The first 492 and second 496 gaps form a vapor passageway that guides the sterile LN₂ vapor in a substantially serpentine downward path 498 along a vertical length of the tubes 466, 468, 470, 472 to maintain cooled gas cooling of the tubes 466, 468, 470, 472. It is understood that other path shapes may be used. The sterile LN₂ vapor then impinges on the frozen particles 282 located in the funnel 290 (see also FIG. 3A) to maintain the frozen particles 282 in a frozen state or to freeze drops 242 of liquid product or frozen particles 282 that are semi-frozen after exiting the tubes 466, 468, 470, 472. In an alternate embodiment, the outer 484 and inner 482 walls may extend past an end 500 of the tubes 466, 468, 470, 472 to enable impingement of the sterile LN₂ on the frozen particles prior to entering the funnel 290.

Thus, the freeze drying system 200 in accordance with aspects of the invention enables a continuous freeze drying process. In addition, the freeze dried product 284 manufactured in accordance with aspects of the invention is manufactured without using tray dryers in which bulk product is manually loaded into trays, freeze dried, and then manually removed from the trays. The freeze dried product 284 manufactured in accordance with aspects of the invention does not require milling to achieve a suitable powder size and uniformity. Further, aspects of the invention provide an improved technique for processing bulk quantities of aseptic materials in a controlled, aseptic environment.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

1. A freeze drying vessel for a freeze drying system having a freezing vessel that generates frozen product particles by freezing drops of fluid product, comprising:
a freeze drying chamber having a drying chamber inlet that receives the frozen particles, a vacuum port through which the drying chamber is evacuated to a first vacuum pressure and a drying chamber outlet;
a plurality of moveable product transfer belts wherein each belt is moved by a rotating driven drum that is horizontally spaced apart from an idler drum to form a plurality of horizontal product transfer surfaces that transport the frozen particles wherein each product transfer surface is arranged vertically in the drying chamber and moves in an opposite horizontal direction than a lower product transfer surface and wherein the product transfer surfaces include top and bottom product transfer surfaces wherein the top product transfer surface receives the frozen particles from the drying chamber inlet;
at least one product removal device located adjacent each driven drum, wherein the at least one product removal device removes frozen particles from an end of each product transfer surface, respectively, to enable the removed frozen particles to flow downward to a lower product transfer surface; and
at least one heating element located adjacent each product transfer surface, wherein the at least one heating element heats the frozen particles to promote sublimation of the frozen particles to form freeze dried product in powder form that flows downward from the bottom product transfer surface and is discharged through the drying chamber outlet.

2. The freeze drying vessel according to claim 1, further including a belt tensioner that is spaced vertically downward from each product transfer surface.

3. The freeze drying vessel according to claim 1, wherein at least one product transfer surface is located between upper and lower heating elements.

4. The freeze drying vessel according to claim 1, wherein each driven drum is magnetically coupled to a chamber drive system located outside of the drying chamber to rotate an associated driven drum.

5. The freeze drying vessel according to claim 1, wherein each driven drum is attached to an external drive system via an associated drive shaft that extends through a wall of the drying chamber and further including an axial seal system to seal each drive shaft to maintain an aseptic environment within the drying chamber.

6. The freeze drying vessel according to claim 1, wherein the at least one product removal device includes a scraper blade element.

7. The freeze drying vessel according to claim 1, wherein the freezing vessel includes at least one tube and the at least one tube defines a freezing chamber for forming the frozen particles, wherein a sterile liquid nitrogen vapor contacts an outside of each tube to cool each tube and the sterile liquid nitrogen vapor also contacts drops of liquid product or semi-frozen particles when exiting each tube.

8. The freeze drying vessel according to claim 1, wherein an intermediate chamber is located between the freezing vessel and the freeze drying vessel wherein the intermediate chamber includes first and second valves wherein the first valve is opened to receive the frozen particles from the freezing vessel into the intermediate chamber and wherein the first valve is subsequently closed to evacuate the intermediate chamber to the first vacuum pressure wherein the second valve is subsequently opened to enable the frozen particles to drop by gravity from the intermediate chamber through the drying chamber inlet and into the drying chamber.

9. A freeze drying vessel for a freeze drying system having a freezing vessel that generates frozen product particles by freezing drops of fluid product, comprising:
a freeze drying chamber having a drying chamber inlet that receives the frozen particles, a vacuum port through which the drying chamber is evacuated to a first vacuum pressure and a drying chamber outlet;
a plurality of moveable product transfer belts wherein each belt is moved by a rotating driven drum that is horizontally spaced apart from an idler drum to form a plurality of horizontal product transfer surfaces that transport the frozen particles wherein each product transfer surface is arranged vertically in the drying chamber and moves in an opposite horizontal direction than a lower product transfer surface and wherein the product transfer surfaces include top and bottom product transfer surfaces;
an inlet product distribution device located between the drying chamber inlet and the top product transfer surface wherein the inlet product distribution device receives the frozen particles from the drying chamber inlet and arranges the frozen particles into a substantially even layer on the top product transfer surface;
at least one product removal device located adjacent each driven drum, wherein the at least one product removal device removes frozen particles from an end of each product transfer surface, respectively, to enable the removed frozen particles to flow downward to a lower product transfer surface;
a belt product distribution device associated with the at least one product removal device, wherein each belt product distribution device arranges the frozen particles into a substantially even layer on a lower product transfer surface; and
at least one heating element located adjacent each product transfer surface, wherein the at least one heating element heats the frozen particles to promote sublimation of the frozen particles to form freeze dried product in powder form that flows downward from the bottom product transfer surface and is discharged through the drying chamber outlet.

10. The freeze drying vessel according to claim 9, further including a belt tensioner that is spaced vertically downward from each product transfer surface.

11. The freeze drying vessel according to claim 9, wherein at least one product transfer surface is located between upper and lower heating elements.

12. The freeze drying vessel according to claim 9, wherein each driven drum is magnetically coupled to a chamber drive system located outside of the drying chamber to rotate an associated driven drum.

13. The freeze drying vessel according to claim 9, wherein each driven drum is attached to an external drive system via an associated drive shaft that extends through a wall of the drying chamber and further including an axial seal system to seal each drive shaft to maintain an aseptic environment within the drying chamber.

14. The freeze drying vessel according to claim 9, wherein the at least one product removal device includes a scraper blade element.

15. The freeze drying vessel according to claim 9, wherein the freezing vessel includes at least one tube and the at least one tube defines a freezing chamber for forming the frozen particles, wherein a sterile liquid nitrogen vapor contacts an outside of each tube to cool each tube and the sterile liquid nitrogen vapor also contacts drops of liquid product or semi-frozen particles when exiting each tube.

16. The freeze drying vessel according to claim 9, wherein an intermediate chamber is located between the freezing vessel and the freeze drying vessel wherein the intermediate chamber includes first and second valves wherein the first valve is opened to receive the frozen particles from the freezing vessel into the intermediate chamber and wherein the first valve is subsequently closed to evacuate the intermediate chamber to the first vacuum pressure wherein the second valve is subsequently opened to enable the frozen particles to drop by gravity from the intermediate chamber through the drying chamber inlet and into the drying chamber.

17. The freeze drying vessel according to claim 9, wherein the inlet product distribution device includes an array of vertical plate elements arranged to form a substantially even layer of frozen particles on the top product transfer surface.

18. The freeze drying vessel according to claim 9, wherein the inlet product distribution device includes a vibratory element that vibrates the frozen particles to provide a substantially even layer of frozen particles on the top product transfer surface.

19. A method of moving and heating freeze dried product in a freeze drying vessel for a freeze drying system having a freezing vessel that generates frozen product particles by freezing drops of fluid product, comprising:
providing a freeze drying chamber having a drying chamber inlet that receives the frozen particles, a vacuum port through which the drying chamber is evacuated to a first vacuum pressure and a drying chamber outlet;
moving a plurality of moveable product transfer belts having a plurality of horizontal product transfer surfaces that transport the frozen particles wherein each product transfer surface is arranged vertically in the drying chamber and moves in an opposite horizontal direction than a lower product transfer surface and wherein the product transfer surfaces include top and bottom product transfer surfaces wherein the top product transfer surface receives the frozen particles from the drying chamber inlet;
removing frozen particles from an end of each product transfer surface, respectively, to enable the removed frozen particles to flow downward to a lower product transfer surface; and
heating the frozen particles to promote sublimation of the frozen particles to form freeze dried product in powder form that flows downward from the bottom product transfer surface and is discharged through the drying chamber outlet.

20. The method according to claim 19, further including providing an inlet product distribution device located between the drying chamber inlet and the top product transfer surface wherein the inlet product distribution device receives the frozen particles from the drying chamber inlet and arranges the frozen particles into a substantially even layer on the top product transfer surface.
